(19) United States
(12) Patent Application Publication
(10) Pub. No.: US 2011/0181480 A1
(43) Pub. Date: Jul. 28, 2011

(54) ANTENNA MODULE

(75) Inventors: TSUNG-LIN HSIEH, Tu-Cheng (TW); HSIN-HUNG LIU, Tu-Cheng (TW)

(73) Assignee: CHI MEI COMMUNICATION SYSTEMS, INC., Tu-Cheng City (TW)

(21) Appl. No.: 12/764,204

(22) Filed: Apr. 21, 2010

(30) Foreign Application Priority Data
Jan. 27, 2010 (TW) 99102325

(51) Int. Cl. H01Q 9/04; H01Q 13/10

(52) U.S. Cl. 343/767; 343/700 MS

(57) ABSTRACT

An antenna module used in a portable wireless communication device includes an antenna and a base board. The antenna includes a main portion, a feeding portion, and a grounding portion. The feeding portion and the grounding portion connect to the base board. The base board defines a first slit and a second slit. A coupling area is formed between the first slit and the second slit to resonate with the antenna.

### BACKGROUND

1. Technical Field

The disclosure generally relates to antenna modules, particularly to an antenna module having broad working frequency bands.

2. Description of Related Art

Antennas are usually assembled in a portable wireless communication device to send and/or receive signals. However, it is difficult for a portable wireless communication device to obtain a desired communication quality using an antenna having narrow working frequency bands.

Therefore, there is room for improvement within the art.

### BRIEF DESCRIPTION OF THE DRAWINGS

Many aspects of the antenna module can be better understood with reference to the following drawings. The components in the drawings are not necessarily drawn to scale, the emphasis instead being placed upon clearly illustrating the principles of the antenna module.

FIG. 1 shows an exploded, schematic view of an antenna module, according to an exemplary embodiment.

FIG. 2 shows an antenna of the antenna module of FIG. 1.

FIG. 3 shows a schematic view of the antenna module of FIG. 1 with the antenna mounted on a base board.

FIG. 4 is similar to FIG. 3, but shown from another aspect.

FIG. 5 shows a test graph obtained from the antenna module of FIG. 1 and an antenna module having no slit, disclosing return loss varying with frequency.

### DETAILED DESCRIPTION

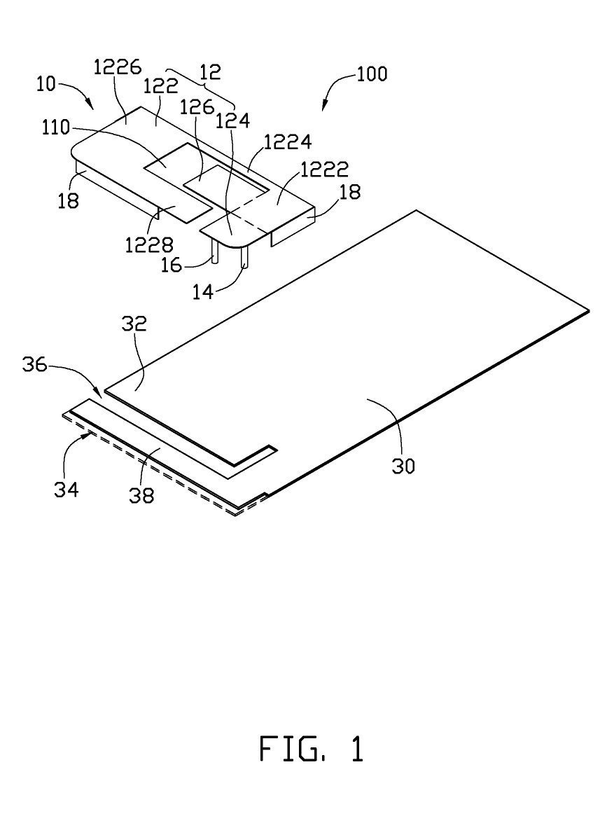

Referring to FIG. 1, an antenna module 100 used in wireless communication devices (not shown), such as a mobile phone and a personal digital assistant (PDA), to receive and/or send signals, according to an exemplary embodiment, includes an antenna 10 assembled in a base board 30.

The antenna 10 is an invert-F and dual-band antenna, and can be made of metal. The antenna 10 includes a main body 12, a feeding portion 14, and a grounding portion 16. The main body 12 is substantially a rectangular sheet. The main body 12 defines a slot 110 and correspondingly forms a first radiating portion 122, a matching portion 124, and a second radiating portion 126.

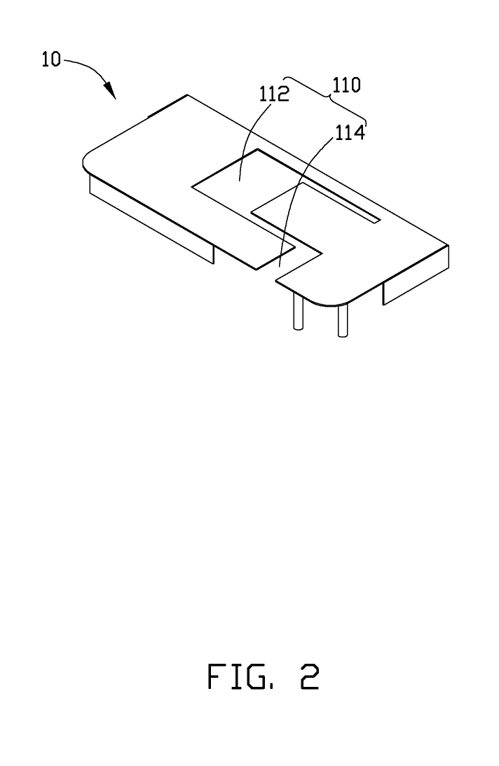

Referring to FIG. 2, the slot 110 includes a first U-shaped portion 112 and a second strip-shaped portion 114 communicating with the first portion 112. The first portion 112 is defined in a central portion of the main body 12. The second portion 114 extends from one end of the first portion 112 to one edge of the main body 12.

The first radiating portion 122 is for receiving and/or sending low frequency band signals. The first radiating portion 122 is substantially a frame including a first end 1222, a first section 1224, a second wider section 1226, and a second end 1228 connected perpendicular in order. Two strip-shaped bent portions 18 connects perpendicularly to outer edges of the first end 1222 and the second end 1228 to adjust working frequency of the first radiating portion 122. The matching portion 124 is substantially a rectangular sheet extending from one end of the first end 1222 and aligning with the second end 1228 of the first radiating portion 122 with the second portion 114 of the slot 110 therebetween. The second radiating portion 126 is for receiving and/or sending high frequency band signals. The second radiating portion 126 is substantially a rectangular sheet connecting perpendicularly to one edge of the first end 1222 and facing the first portion 112 of the slot 110.

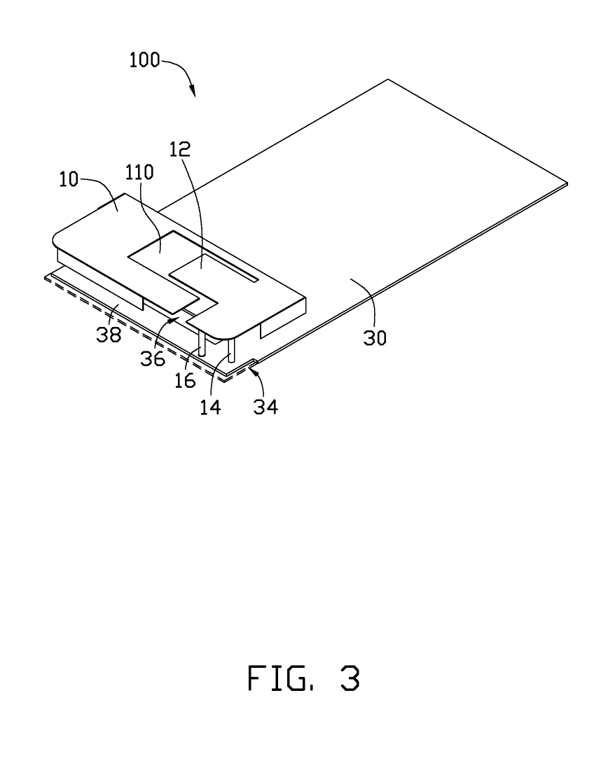

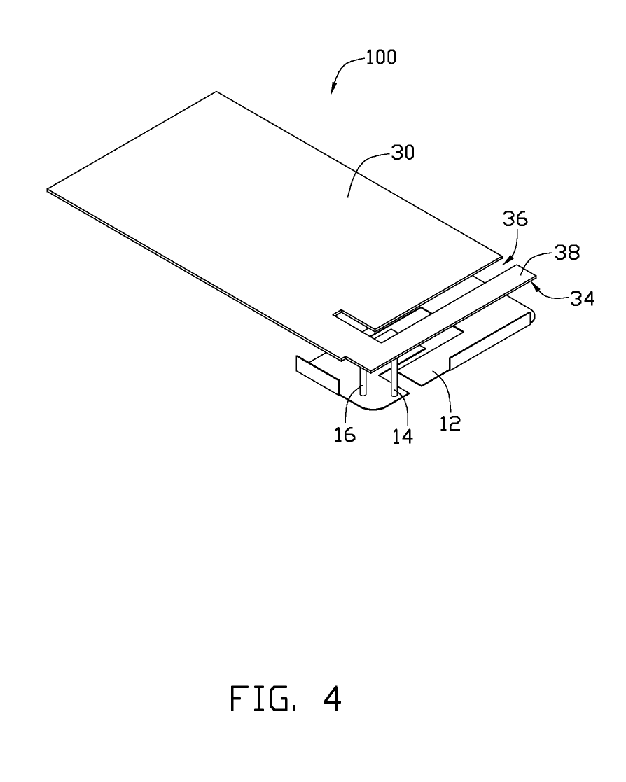

Referring to FIGS. 3 and 4, the feeding portion 14 and the grounding portion 16 are two posts connected perpendicularly to one side of the matching portion 124. Ends of the feeding portion 14 and the grounding portion 16 are connected to the base board 30 to receive signals from or send signals to the base board 30.

The base board 30 is a rectangular printed circuit board (PCB). A mounting area 32 is disposed on the base board 30 to mount the antenna 10 and other electronic members (not shown) such as a speaker and a vibrator. The base board 30 defines a first L-shaped slit 34 along two adjacent edges and a second L-shaped slit 36 spaced from the first slit 34 in the mounting area 32. A coupling area 38 is formed between the first slit 34 and the second slit 36. The electrical length of the coupling area 38 is substantially 1/4 wavelength of signals sent/received by the second radiating portion 126. A feeding point (not shown) and a grounding point (not shown) are disposed on the coupling area 38. The feeding portion 14 and the grounding portion 16 respectively connect to the feeding point and the grounding point and suspend the main body 12 over the base board 30.

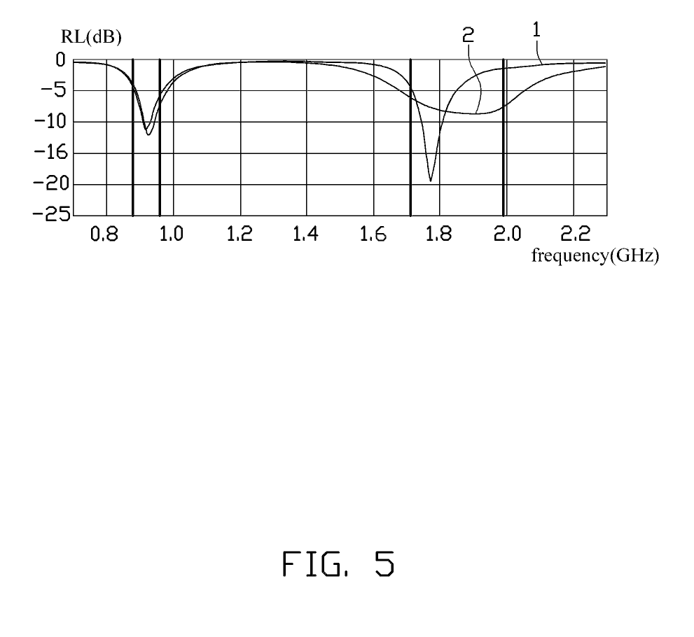

To use the antenna module 100 to send and/or receive signals, the coupling area 38 resonates with the antenna 10, and broadens the high working frequency band of the antenna 10 by resonances generated by the coupling area 38 and the main body 12. Referring FIG. 5, the curve 1 represents return loss varying with frequency obtained from the antenna 10 assembled in a base board 30 without the first slit 34 and the second slit 36; the curve 2 represents return loss varying with frequency obtained from the antenna 10 assembled in the base board 30 defining the first slit 34 and the second slit 36. The high frequency band of the antenna module 100 is broadened from about 1.7˜1.8 GHz to 1.7˜2.0 GHz.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna module used in a portable wireless communication device, comprising:
an antenna including a main portion, a feeding portion and a grounding portion; and
a base board defining a first slit and a second slit and forming a coupling area formed between the first slit and the second slit; wherein the feeding portion and the grounding portion are connected to the base board, the coupling area resonates with the antenna.

2. The antenna module as claimed in claim 1, wherein a mounting area is disposed on the base board, the base board defined the first slit and the second slit in the mounting area, the main body of the antenna is over the mounting area.

3. The antenna module as claimed in claim 2, wherein the first slit is L-shaped formed along two adjacent edges of the base board.

4. The antenna module as claimed in claim 2, wherein the second slit is L-shaped and spaced from the first slit.

5. The antenna module as claimed in claim 1, wherein the main body defines a slot and forms a matching portion, a first radiating portion for receiving and/or sending low frequency band signals and a second radiating portion for receiving and/or sending high frequency band signals by the slot.

6. The antenna module as claimed in claim 5, wherein the slot includes a first U-shaped portion and a second strip-shaped portion communicating with the first portion.

7. The antenna module as claimed in claim 6, wherein the first radiating portion is a rectangular frame including a first end, a first section, a second section, and a second end connecting perpendicularly in order.

8. The antenna module as claimed in claim 6, wherein the matching portion extends from one end of the first end and adjacent to the second portion of the slot.

9. The antenna module as claimed in claim 6, wherein the second radiating portion connects perpendicularly to one edge of the first end and faces the first portion of the slot.

10. The antenna module as claimed in claim 5, wherein the electrical length of the coupling area is ¼ wavelength of signals sent/received by the second radiating portion.

11. The antenna module as claimed in claim 1, wherein the base board is a printed circuit board.
